(19) United States
(12) Patent Application Publication
(10) Pub. No.: US 2024/0387062 A1
(43) Pub. Date: Nov. 21, 2024

(54) FAST IGNITION FUSION SYSTEM AND METHOD

(71) Applicant: Blue Laser Fusion, Inc., Palo Alto, CA (US)

(72) Inventors: Shuji NAKAMURA, Palo Alto, CA (US); Hiroaki OHTA, Palo Alto, CA (US)

(21) Appl. No.: 18/319,368

(22) Filed: May 17, 2023

(51) Int. Cl. G21B 1/23

(52) U.S. Cl. CPC G21B 1/23

(57) ABSTRACT

According to the present invention, techniques including a system and method for a fusion reactor for initiating a fusion reaction are provided. The system includes a first laser beam configured for irradiating a fuel pellet with the first laser beam having a first pulse energy power density emitted from a plurality of nanosecond laser light sources for a predetermined time. The system also includes a second laser beam configured for irradiating the fuel pellet with the second laser beam having a second pulse energy power density emitted from a plurality of picosecond laser light sources to cause ignition of a fusion reaction.

### BACKGROUND OF INVENTION

The present invention relates generally to fusion energy generation techniques. In particular, the present invention provides a system and method for fusion energy using a high intensity pulse laser generation system, and related methods. More particularly, the present invention provides a synchronized light source using fast ignition for laser fusion using a boron fuel target. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

From the beginning of time, human beings have developed energy sources from natural materials such as wood, coal, oil, and gas products. Unfortunately, burning wood and coal leads to major pollution issues, including adding undesirable carbon particles into the atmosphere. Oil and gas products also have similar limitations and have been a leading cause of “Global Warming.” Renewable energy sources including nuclear, wind, hydroelectric, and solar are promising. However, such renewable energy sources have other shortcomings. Wind only works if the wind is blowing. Solar cannot be used when the sun goes down. Hydroelectric is limited to areas with water, and nuclear, although promising, has had major problems in generating waste and unreliable and dangerous reactors. One other promising energy source has been fusion energy.

Fusion energy is a type of energy production that occurs when two atomic nuclei fuse together, releasing a large amount of energy in the process. It is considered a potential source of clean and abundant energy, as the fuel for fusion reactions (mainly hydrogen) is abundant on Earth and the reactions produce no greenhouse gases or other harmful pollutants.

There are two main approaches to achieving fusion reactions: inertial confinement fusion (ICF) and magnetic confinement fusion (MCF).

Inertial confinement fusion (ICF) involves using high-energy lasers or particle beams to compress and heat a small pellet of hydrogen fuel, causing it to fuse. The fuel is typically a mixture of deuterium and tritium, two isotopes of hydrogen. The fuel is contained within a small, spherical capsule called a hohlraum, which is placed at the center of a chamber filled with high-energy lasers or particle beams. When the lasers or particle beams are fired at the hohlraum, they create a uniform layer of x-rays that uniformly heat and compress the fuel inside the hohlraum. This causes the fuel to reach the necessary temperature and pressure conditions for fusion to occur

The main advantage of ICF is that it can potentially produce fusion reactions with a relatively small amount of fuel and at a relatively low cost. However, the process is still in the experimental stage and there are significant technical challenges to before it can be considered a practical source of energy.

Magnetic confinement fusion (MCF) involves using strong magnetic fields to contain and heat a plasma (a hot, ionized gas) of hydrogen fuel, causing it to fuse. The most common type of MCF is called tokamak fusion, which uses a toroidal (doughnut-shaped) chamber to contain the plasma. The plasma is held in the center of the chamber by strong magnetic fields, which are created by running current through a set of coil windings around the chamber. The plasma is heated by injecting energy into it, either through particle beams or through electromagnetic waves.

The main advantage of MCF is that it has the potential to produce fusion reactions on a larger scale, making it more suitable for generating electricity. However, it is a more complex and costly process than ICF and there are still significant technical challenges to overcome before it can be considered a practical source of energy.

Both ICF and MCF have made significant progress in recent years and there are several experimental facilities around the world working on these technologies. However, achieving sustained fusion reactions with net energy production (meaning the energy produced by the fusion reactions is greater than the energy required to initiate and sustain the reactions) remains a major technical challenge.

There are also other approaches to fusion energy being explored, such as magnetized target fusion and muon-catalyzed fusion. However, these approaches are still in the early stages of development. It is not yet clear if fusion energy will be viable as a source of energy.

From the above, fusion energy has the potential to be a clean and abundant source of energy, but significant technical challenges must be overcome before it can be considered a practical source of energy.

### SUMMARY OF INVENTION

According to the present invention, techniques related generally to fusion energy generation are provided. In particular, the present invention provides a system and method for fusion energy using a high intensity pulse or CW laser generation system, and related methods. More particularly, the present invention provides a synchronized light source for laser fusion using a boron or deuterium and tritium (DT) fuel target. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

In an example, the present invention provides a method of initiating a fusion reaction. The method includes irradiating a fuel pellet uniformly and symmetrically with first laser beam having a first pulse power density emitted from a plurality of nanosecond laser light sources for a predetermined time to compress the target of the pellet uniformly and symmetrically. The method includes irradiating the fuel pellet with a second laser beam having a second pulse power density emitted from a plurality of picosecond laser light sources to cause ignition of a fusion reaction after compressing the target by first nanosecond laser light sources. This technique of using two kinds of laser light pulse sources is called as a fast ignition to reduce the ignition temperature dramatically by an order of one or two or more.

In an alternative example, the present invention provides a fusion reactor system for initiating a fusion reaction. The system includes a first laser beam configured for irradiating a fuel pellet with the first laser beam having a first pulse energy power density emitted from a plurality of nanosecond laser light sources for a predetermined time. The system also includes a second laser beam configured for irradiating the fuel pellet with the second laser beam having a second pulse power density emitted from a plurality of picosecond laser light sources to cause ignition of a fusion reaction. In an example, the first laser beam is inside of a Fabry-Perot.

Depending upon the example, the present invention can achieve one or more of these benefits and/or advantages. In an example, the present invention provides a fusion energy system including a high intensity pulse or continuous wave (CW) laser system configured with a reactor in a compact and spatially efficient system and related methods. In an example, the high intensity pulse or CW laser system provides enough energy to ignite and sustain fusion energy within the reactor. In an example, the present invention offers advantages of generating fusion power through an efficient size, weight, and cost using the present high intensity lasers. These and other benefits and/or advantages are achievable with the present device and related methods. Further details of these benefits and/or advantages can be found throughout the present specification and more particularly below.

A further understanding of the nature and advantages of the invention may be realized by reference to the latter portions of the specification and attached drawings.

### BRIEF DESCRIPTION OF DRAWINGS

In order to more fully understand the present invention, reference is made to the accompanying drawings. Understanding that these drawings are not to be considered limitations in the scope of the invention, the presently described examples and the presently understood best mode of the invention are described with additional detail through use of the accompanying drawings in which:

FIG. 1 is a simplified top-view diagram of a fusion reactor system configured with a group of optical cavities and a group of direct laser light sources according to an example of the present invention.

FIG. 2 is a simplified diagram of an optical cavity region configured with a pair of movable mirror devices according to an example of the present invention.

FIG. 3 is a simplified top-view diagram of a fusion reactor system configured with an optical cavity with a pair of movable mirrors according to an example of the present invention.

### DETAILED DESCRIPTION OF THE EXAMPLES

According to the present invention, techniques related generally to fusion energy generation are provided. In particular, the present invention provides a system and method for fusion energy using a high intensity pulse or CW laser generation system, and related methods. More particularly, the present invention provides a synchronized light source for laser fusion using a boron fuel or deuterium and tritium (DT) target. Merely by way of example, the invention can be applied to a variety of applications, including energy generation for power, spaceships, travel, other vehicles for air, land, and water, defense applications (e.g., satellite, aerospace, land and missile defense, submarines, boats), biotechnology, chemical, mechanical, electrical, and communication and/or data applications.

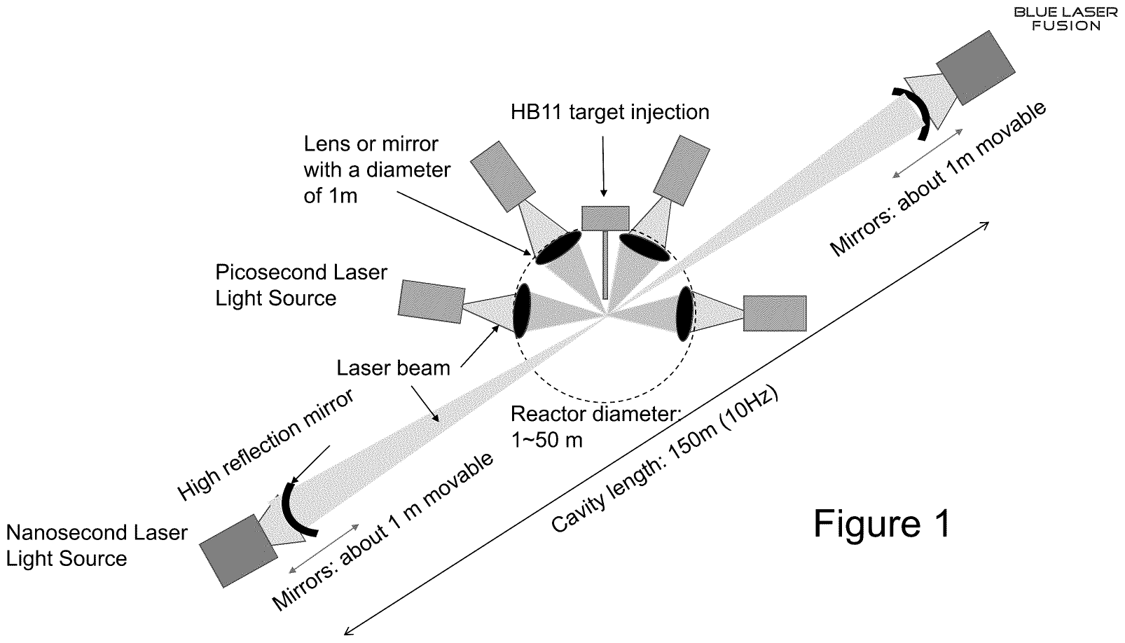

FIG. 1 is a simplified top-view diagram of a fusion reactor system configured

with a group of optical cavities and a group of direct laser light sources according to an example of the present invention. As shown is an inertial fusion reactor system. The system has a reactor housing having an interior region, an exterior region, and a reaction region configured within a center region of the interior region. In an example, the reactor housing is made of suitable material to withstand mechanical, chemical, thermal, and high intensity electromagnetic radiation. As shown, the system has a plurality of picosecond laser light sources numbered from 1 to N, where N ranges from 1 to 20 or more. The light sources are arranged in a pattern around the center region. The pattern can be symmetric, concentric, among others. In an example, a laser beam characterized by a wavelength, a pulse frequency, a pulse width, and a pulse energy is emitted from each of the picosecond laser sources. The laser beam is focused and targeted to a fuel pellet injected within the reaction region. In a preferred example, a plurality of laser beams are combined within a vicinity of the fuel pellet.

As further shown, the system has a plurality of Fabry Perot cavity regions numbered from 1 to M, where M is 50 to 500 or more. The cavity regions are arranged symmetrically around the center region and forming a hub and spoke pattern such that the hub is concentric with the reaction region.

In an example, a pair of nanosecond laser light sources are configured, respectively, to a first mirror device and a second mirror device coupled to each Fabry Perot cavity regions. In an example, a first laser beam and a second laser beam from the pair of nanosecond laser light sources collectively propagate between the first mirror device and the second mirror device to increase in energy intensity from a first intensity to a second intensity to an P^{th} intensity for P cycles of the combined laser beams, where P is greater than 10,000 cycles. In an preferred example, the plurality of Fabry Perot cavity regions irradiate and combine at the center region to create a high intensity pulse laser beam.

In an example, the fusion system includes 200 or more Fabry Perot cavity regions. Each of the cavity regions is configured with a pair of nanosecond (ns) laser light sources. In an example, the system has 10 picosecond light sources comprising 100 picosecond (ps) laser light sources each with 1 kJ pulse energy (10×1kJ). In an example, the 10 systems of ps laser light sources are characterized by 10×1kJ with a 1 ps pulse width surround the reactor to create a total power from ps laser light sources to achieve 100 kJ.

In an example, the high intensity picosecond laser light source is a mode-locked laser, which uses a nonlinear optical element, such as a saturable absorber or a passive mode locker, to generate short pulses. Mode-locked lasers can produce very short pulses, with pulse durations ranging from femtoseconds to picoseconds. They are highly stable and can produce very high peak powers, making them ideal for many scientific and research applications.

An example of an optical enhancement cavity (OEC) configured from a Fabry Perot cavity can be found in U.S. Ser. No. 18/295,764 filed Apr. 4, 2023; U.S. Ser. No. 18/172,885 filed on Feb. 22, 2023; U.S. Ser. No. 18/149,644 filed on Jan. 3, 2023; U.S. Ser. No. 18/157,515 filed on Jan. 20, 2023; U.S. Ser. No. 18/161,717 filed on Jan. 30, 2023; U.S. Ser. No. 18/161,730 filed on Jan. 30, 2023; and U.S. Ser. No. 18/161,738 filed on Jan. 30, 2023, each of which is commonly assigned, and hereby incorporated by reference in its entirety for all purposes.

As also shown is a dispenser apparatus for a fuel pellet. The dispenser apparatus is described in U.S. Ser. No. 18/157,515 filed Jan. 20, 2023, commonly assigned, and hereby incorporated by reference for all purposes.

In an example, the present invention provides a method of initiating a fusion reaction. The method includes irradiating a fuel pellet with first laser beam using the OEC having a first pulse energy power density emitted from a plurality of nanosecond laser light sources for a predetermined time. OEC laser has a uniform intensity, narrow spectrum width and other many advantages of laser beam quality because the OEC laser beams of inside of Fabry-Perot (FP) cavity are used to compress the target uniformly and symmetrically. Most if not all of conventional lasers are outside of the FP cavity. Thus, the beam quality of conventional lasers easily becomes poor after leaving the FP cavity due to a lack of control of Fabry-Perot cavity. Considering about these, the OEC laser would have the best laser beam quality among the convectional lasers at this time. The National Ignition Facility or NIF of Lawrence Livermore National Laboratory (LLNL) announced the first ignition using the hohlraum on Dec. 5, 2022. The reason why NIF used the hohlraum is that the laser beam is not uniform. By irradiating the laser beam into hohlraum, the hohlraum emits X-ray and the emitted X-ray irradiate the DT pellet uniformly. Using the OEC laser, the laser beam quality is so good including the uniformity of laser beams, and thus, the hohlraum would not be required for the ignition in some examples. Using the OEC nanosecond lasers, the target is uniformly compressed, and then, after the uniform compression of the target, the second picosecond pulse could ignite the target directly without the hohlraum. The method includes irradiating the fuel pellet with a second laser beam having a second pulse energy power density emitted from a plurality of picosecond laser light sources to cause ignition of a fusion reaction.

In an example, the second pulse energy power density is greater than the first pulse power density. In an example, the irradiation of the second laser beam occurs within the predetermined time. In an example, each of the nanosecond laser light sources is characterized by a nanosecond pulse time ranging from 1 ns to 20 ns. Each of the picosecond laser light sources is characterized by a picosecond pulse time ranging from 0.5 ps to 5 ps in an example. In an example, the ps pulse is focused to the pellet after improving laser power density distribution with deformable mirrors. In an example, the ns pulse is focused to the pellet using concave mirrors.

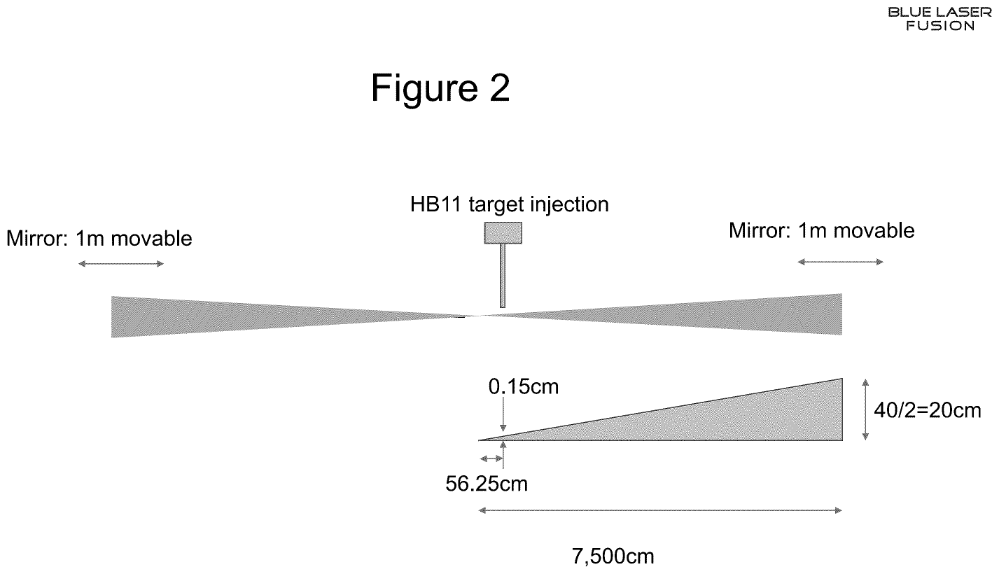

FIG. 2 is a simplified diagram of an optical cavity configured with a pair of movable mirror devices according to an example of the present invention. As shown, the optical cavity is formed between a pair of movable mirror devices. In an example, each of the pairs of mirror devices is spatially adjustable in a longitudinal direction along a direction of a length of the cavity from 10 centimeters to 100 centimeters, as shown. Other variations can include shorter spatial adjustments and longer spatial adjustments depending upon the application.

The target or pellet size is variable from 1 mmϕ to 5 mmϕ depending on how much electric power is generated. Using the concave mirrors, OEC laser is focused into the center of the Fabry Perot (FP) cavity. At the center, the laser beam spot size is controlled less than 1 mmϕ by making the special concave mirror with a certain curvature. When the target size becomes 2 mm or 3 mm, at the center of FB cavity, laser beam cannot irradiate whole area of the target uniformly because the laser beam spot size is less than 1 mm at the center. When the pair of mirrors are moved to 56.25 cm along the cavity direction as shown in FIG. 2, the beam diameter becomes 3 mm, and then the 3 mm size target is irradiated by the OEC laser uniformly. Thus, the pair of mirrors have to be moved to up top 1 m to accommodate the target size of up to 4˜5 mm. The OEC laser are used to compress the target. Thus, the OEC lasers has to be irradiated to the target uniformly an symmetrically.

In an example using boron, a size of the boron based fuel pellet has a size ranging from 1 mm to 3 mm. In an example, the nanosecond pulse is characterized by a pulse of 1 to 20 ns. In an example, using the 3 mm sized boron fuel pellet, the dispenser injects the boron fuel pellet at 56.25 centimeters away from the center region of cavity region.

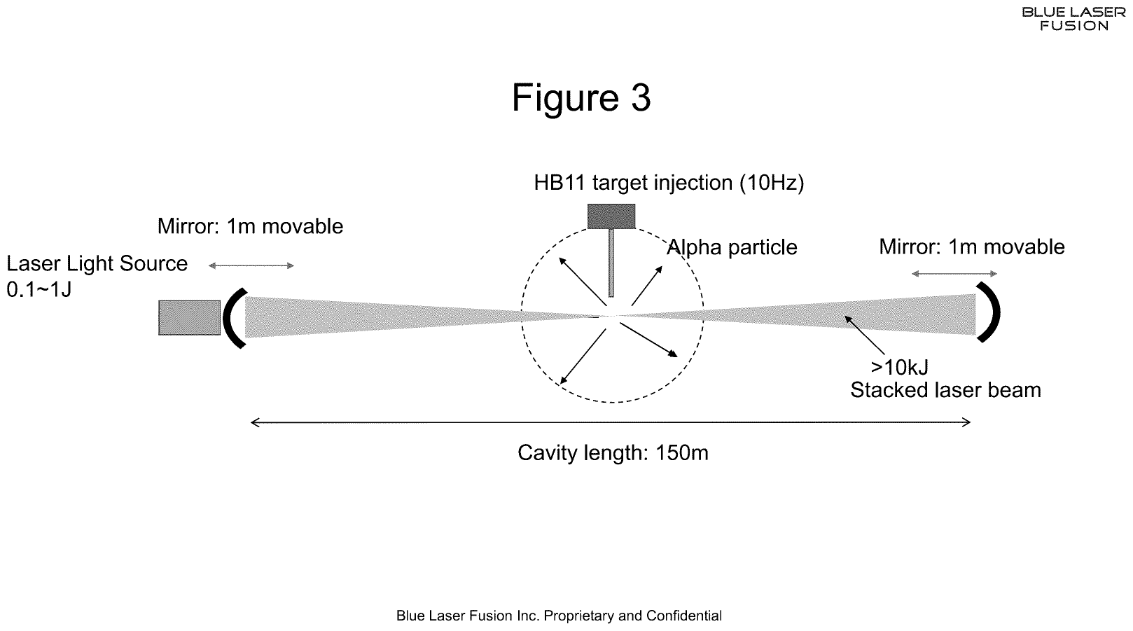

FIG. 3 is a simplified top-view diagram of a fusion reactor system configured with an optical cavity region with a pair of movable mirrors according to an example of the present invention. As shown, the fusion reactor system has an optical cavity region including a pair of mirror devices. Each of the mirror devices is movable and also deformable and concave mirror. In an example, the system has a dispenser apparatus configured to inject a boron based fuel pellet. A plurality of optical cavity regions are configured together in a hub and spoke configuration to create a high intensity energy at an intersection region to facilitate a fusion reaction.

In an example, the present invention provides a method of using an inertial

nuclear fusion reactor using a laser device for energy generation. Such fusion reactor can be similar to the same as any of the aforementioned examples. In an example, the method includes maintaining a vacuum in a reactor housing. The reactor housing has an interior region and is characterized by a diameter extending across a cross-section of the interior region. The reactor housing has a reaction region within a vicinity of a spatially center region of the reactor housing and a peripheral region formed within an interior of the reactor housing. The peripheral region surrounds the reactor region and includes a plurality of peripheral regions.

In an example, the method includes emitting an electromagnetic radiation from a nanosecond (ns) laser light source comprising a first ns laser light source and a second ns laser light source. The first ns laser light source and the second ns laser light source are configured, respectively, to emit the electromagnetic radiation coupled to a pair of mirror devices, as shown. The pair of mirrors are configured, respectively, on the first end and the second end of a cavity region. The cavity length is defined by spatial length between each pair of mirrors is larger than a diameter of the reactor housing in an example.

The method includes propagating a first laser beam from the first ns laser light source and propagating a second laser beam from the second ns laser light source to collectively combine to increase in energy intensity from a first intensity to a second intensity to an Mth intensity for M cycles, where M is greater than 1,000 cycles at a cavity region. In an example, the cavity region is configured with a plurality of cavity regions numbered from 1 through N within the interior region of the reactor housing and spatially configured around the peripheral region. Each of the plurality of cavity regions extends from a first side of the peripheral region to a second side of the peripheral region. The first side is opposing the second side. The cavity region forming a linear path along the diameter of the interior region. The plurality of cavity regions forms a hub and spoke configuration. Each cavity region has a center region concentric with the reactor region and each cavity region has a first end coupled to the first side and a second end coupled to the second side of the peripheral region. N is greater than 1.

In an example, the method includes using a plurality picosecond laser light sources numbered from 1 through P spatially configured with the reactor housing to emit a electromagnetic radiation from each picosecond (ps) laser light source coupled to an optical element. The optical element includes at least a mirror or a lens to make the focused beam. The mirror is a deformable mirror. The radiation passes through a transparent glass to enter the interior region of the reactor housing, and is configured to form a focused laser beam from the plurality of picosecond laser light sources to irradiate into a fuel pellet with a predetermined spot size.

In an example, the method includes initiating ignition of at least boron, a boron isotope 11, DT, or a proton plus a boron isotope 11 provided in the fuel pellet or a container comprising the fuel pellet. The fuel pellet is injected within the reactor region and is operably coupled to the plurality of ps laser light sources at the reaction region of the reactor housing for the ignition at an intersection of the plurality of cavity regions using an energy level sufficient to compress the fuel pellet for a fusion reaction using the first laser beam and the second laser beam from each of the cavity regions.

In an example, each of the ns laser light sources comprises a laser device configured to emit electromagnetic radiation at a wavelength ranging from 350 nm to 1070 nm and a frequency between 0.3 MHz and 3 MHz. In an example, each of the ps laser light sources comprises a laser device configured to emit electromagnetic radiation at a wavelength ranging from 350 nm to 1070 nm and a frequency between 1 Hz and 20 Hz.

In an example, the Mth intensified pulse from the ns laser light source is characterized by a frequency of 10 Hz. In an example, the Mth intensified pulse has a pulse energy of about 10 kJ with a frequency of 10Hz. In an example, N is more than 100. In an example, the Mth intensified pulse from the pair of ns laser light sources is focused into the fuel pellet such that the predetermined spot size is substantially a same size as the fuel pellet.

In an example, the method uses a fuel pellet dispenser coupled to the reactor housing, the fuel pellet dispenser configured to inject the fuel pellet at a rate of 10 Hz. In an example, the Mth intensified pulse, each ps laser light source, and a pellet dispenser are synchronized with a frequency of 10 Hz. In an example, each of the ps laser light source with a frequency of 10 Hz.

In an example, each of the pairs of mirror devices is spatially adjustable in a longitudinal direction along a direction of a length of the cavity from 10 centimeters to 100 centimeters.

In an example, each of the plurality of cavity regions has a length of 100 meters to 200 meters. In an example, each of the plurality of cavity regions has a length of 150 meters.

In an example, the reactor housing is characterized by the diameter ranging from 1 m to 50 m.

In an example, each of the ps laser light sources comprises 10 small ps laser light sources. Each of the small ps light sources has a pulse energy of about 1 kJ with a frequency of 10 Hz. In an example, each of the ps laser light sources has a pulse energy of about 10 kJ with a frequency of 10 Hz.

In an example, the plurality of ps laser light sources are focused to the predetermined spot size on the fuel pellet to achieve a pulse power density is more than 1×10²⁰ Wcm⁻², or more than 1×10²¹ Wcm⁻², or more than 1×10²² Wcm⁻².

In an example, each of the ns laser sources has a pulse energy of about 0.1 J with a frequency of 1 MHz.

In an example, the predetermined spot size ranges from 1 mmϕ to 5 mmϕ.

In an example, the energy level is characterized by a laser pulse power density of more than 1×10¹³ Wcm⁻² on the fuel pellet. In an example, the energy level is characterized by a pulse power density of more than 1×10¹⁴ Wcm⁻² on the fuel pellet. In an example, the energy power level is characterized by pulse power density of more than 1×10¹⁵ Wcm⁻² on the fuel pellet. In an example, the energy power level is characterized by a pulse power density of more than 1×10¹⁶ Wcm⁻² on the fuel pellet.

In an example, the Mth intensified pulse from the ns laser light source is irradiated on the fuel pellet to compress the fuel pellet for a time period of 1 ns to 20 ns, among others. Thereafter the compression of the fuel pellet, the ps laser light source characterized by a higher power density, than the ns laser light source, is irradiated into the fuel pellet with the predetermined spot size, that is smaller than a spot size of the target size, on the fuel pellet for the ignition. For examples, the size of focused ps laser spot size on the target is 100˜500 microns depending on the required power density. When the power density is high, the focused spot size becomes smaller.

In an example, the system has a cavity length and uses a light source configured for 1 MHz and 0.1 Joule. The system has a reactor housing, which includes an interior region maintained in a vacuum environment, a plurality of cavities, each of which is formed between a pair of mirrors. Each pair of mirrors has a laser light source on one end and a photodetector on the other end. The system has a pellet supply (or delivery) device or hohlraum supply (or delivery) device, as shown.

In an example, the reactor housing is a vacuum chamber. In an example, a vacuum chamber is a sealed, airtight container that is used to create a vacuum, or a region with a very low pressure. Inside of the cavity is evacuated (or empty), which is a desired condition to increase the intensity of pulse or continuous wave (CW) laser power. In an example, when air or another impurity is in the cavity, particles and waters in the air absorb or scatter the laser light, and the intensity of the laser light is decreased when laser light is propagating in the cavity. In a preferred example, the cavity is maintained in a vacuum.

The vacuum chamber is typically made of a material that is resistant to vacuum, high temperatures, and radiation, such as stainless steel, aluminum or other materials. It is designed to withstand the high radiation and high temperatures that are generated during the fusion reaction, as well as the intense radiation emitted by the fusion products.

In an example, the vacuum chamber is a component of a fusion reactor, as it helps to create the conditions that are necessary for the laser power to increase in the present invention. It also helps to protect the fusion reaction from external influences, such as air and other contaminants, which can interfere with the reaction as well as laser propagation. In an example, the vacuum environment can range from less than 10⁻⁵ torr to 10⁻³ torr. Of course, there can be other variations, modifications, and alternatives.

To create the vacuum in the reactor housing, the vacuum chamber is evacuated using a high-capacity pump, which removes all of the air and other gases from the chamber. This process is known as pumping down the chamber, and it typically takes several hours or much more depending on the size of chambers to achieve the desired vacuum level. Once the vacuum has been achieved, the laser light source(s) is switched on, and pulse or CW laser power is increased in each cavity with a total number of N. The fuel pellet or the container which include the fuel pellet is injected through the tube, and the fusion reaction can begin. A number of N pairs of Fabry-Perot cavities intensify the pulse laser or CW laser inside of the reactor housing in the present invention.

In an example, the system has a reaction region within a vicinity of a spatially center region of the reactor housing. The reaction region is within the center region, as shown. The center region shows an intersection between a plurality of cavity regions. The center region is also configured to form a spot for a plurality of laser beams from a plurality of laser light sources without a cavity region.

The system has a peripheral region formed within an interior of the reactor housing as shown. The peripheral region surrounds the reactor region, and is preferably disposed along a largest diameter of the interior of the reactor housing. The system has a plurality of cavity regions numbered from 1 through N within the interior region of the reactor housing and spatially configured around the peripheral region such that each of the plurality of cavity regions extends from a first side of the peripheral region to a second side of the peripheral region. Preferably, the first side is opposing the second side along a straight line, and forms a linear path along a diameter of the interior region. In an example, the plurality of cavity regions forms a hub and spoke configuration. Each cavity region has a center region concentric with the reactor region and each cavity region has a first end coupled to the first side and a second end coupled to the second side of the peripheral region. In an example, N is greater than 10 and can be 100, 200, or thousands, although there may be fewer cavities in other examples. Each and every laser light source is synchronized with other, the fuel pellet delivery system, and photo detectors, for high power pulsed laser to hit the fuel pellet or the container in the reaction region.

A pair of mirrors are configured, respectively, on the first end and the second end of the cavity regions. Each pair of mirrors are spatially disposed along the peripheral region within the reactor housing. As shown, the system uses any combination of high reflection flat and curved optical mirror devices with a reflectivity of more than 99.99% or 99.999% to minimize an optical loss. In an example, a high reflection optical mirror is a device that reflects light in a specific direction. The device has a flat or curved surface, coated with a high reflective material, such as dielectric materials. The preferred high reflection optical mirror is a dielectric distributed Bragg Reflector (DBR). In an example, the shape and curvature of the mirror determine the direction and intensity of the reflected light.

In the present invention, all of the high intensity laser beams are focused to a small spot in the center of the reactor or the reaction region to achieve a highest laser power density at the center by gathering all of a number of N high intensity laser beams after multiplying laser intensity M times at each cavity. At each cavity composed of a pair of mirrors, a laser light source configured to emit electromagnetic radiation coupled to at least one of the pair of mirror devices such that a laser beam propagating from the laser light source between the pair of mirror devices increases in energy intensity from a first intensity to a second intensity to an Mth intensity for M cycles of the laser beam propagating between the pair of mirror devices.

In an example, a laser light source configured to emit electromagnetic radiation and form a high-power laser beams through each Fabry Perot cavity of inside of the reactor. In an example, the present system couples a high-power pulse or CW laser system to a fusion reactor to create a high-power energy source to initiate and perpetuate a fusion reaction. As an example, laser fusion is a process in which energy is generated through the fusion of atomic nuclei. The process occurs when the nuclei of two or more atoms are brought together and collide at high temperatures and high pressures, causing them to fuse together and release a large amount of energy. In the laser fusion process in an example, a high-energy laser beam is used to compress and heat a small pellet of fuel, typically a mixture of deuterium and tritium (two isotopes of hydrogen). The laser beam creates a shockwave that compresses the fuel by implosion, causing it to reach temperatures and pressures high enough for fusion to occur. During the fusion process, the atomic nuclei of the fuel atoms combine to form a heavier nucleus, releasing a large amount of energy in the form of light, momentum and heat. This energy can then be harnessed and used to generate electricity through the use of an electric generator, as noted.

As an example, a high-power laser is a device that produces a highly concentrated and focused beam of light with a high level of power. The light produced by a high-power laser can have a variety of properties, such as wavelength, intensity, and coherence, which depend on the specific design and construction of the laser.

One type of high-power laser is the solid-state laser, which is made of a solid gain medium that is pumped by an external energy source, such as a flashlamp or another laser. The gain medium is typically a crystal, ceramics or glass rod that is doped with a rare earth element, such as neodymium or ytterbium, to amplify the laser beam. Solid-state lasers are highly efficient and can produce high power outputs, making them ideal for many industrial and scientific applications.

Another type of high-power laser is the gas laser, which uses a gas as the gain medium. Gas lasers can be further classified based on the type of gas used, such as helium-neon lasers, carbon dioxide lasers, and argon lasers. Gas lasers are highly reliable and have a long lifespan, making them suitable for continuous operation.

A high-power laser can also be a hybrid of the two aforementioned types, such as a fiber laser, which uses a doped fiber as the gain medium. Fiber lasers are highly efficient and can produce very high-power outputs, making them ideal for many industrial and scientific applications.

There are many factors that contribute to the performance and efficiency of a high-power laser, such as the gain medium, pump source, resonator design, and cooling system. The design and construction of a high-power laser can greatly impact its performance and suitability for a specific application. As an example, a high-power laser is a highly concentrated and focused beam of light with a high level of power, used in a wide range of applications.

In an example, the present invention provides a high intensity pulse or CW laser generation system. In an example, a high intensity pulse or CW laser is a type of laser that produces a highly concentrated and focused beam of light with a high level of power. The short pulse duration of a high intensity pulse laser allows for high peak power and the ability to deliver the high peak energy to a target in a very short period of time.

In an example, one type of high intensity pulse laser is the Q-switched laser, which uses a mechanical or electro-optical modulator to rapidly switch the laser beam on and off. This allows the laser to produce very short pulses, with pulse durations ranging from nanoseconds to picoseconds. Q-switched lasers are highly efficient and can produce very high peak powers, making them ideal for many industrial and scientific applications. Another type of high intensity pulse laser is the mode-locked laser, which uses a nonlinear optical element, such as a saturable absorber or a passive mode locker, to generate short pulses. Mode-locked lasers can produce very short pulses, with pulse durations ranging from femtoseconds to picoseconds. They are highly stable and can produce very high peak powers, making them ideal for many scientific and research applications.

There are many factors that contribute to the performance and efficiency of a high intensity pulse or CW laser, such as the gain medium, pump source, resonator design, and pulse generation method. The design and construction of a high intensity pulse or CW laser can greatly impact its performance and suitability for a specific application. In an example, a high intensity pulse laser is a type of laser that produces a highly concentrated and focused beam of light with a high level of power and a very short pulse duration. It is used in a wide range of applications. In an example, the present invention provides a high intensity pulse or CW laser generation system and related methods as described throughout the present specification and more specifically below.

In an example, there are several types of high reflection optical mirrors, each with specific properties and uses. Flat mirrors, also known as plane mirrors, have a flat reflecting surface and are used to reflect light in a straight line. In an example, concave mirrors have a curved inward reflecting surface and are used to focus light to a single point. In the present invention, concave mirrors are included to focus the high-power laser into a center of reactor for both of ns and ps laser light sources. In an example, convex mirrors have a curved outward reflecting surface and are used to spread out light over a wider area to reduce the concentration of the laser power at the mirror surface and to avoid optical damage. In an example, optical mirrors can also be coated with specialized coatings, such as dielectric coatings or metallic coatings, to enhance their reflective properties and reduce surface defects, which causes optical absorption resulting in optical damages. These coatings can improve the efficiency and performance of the mirror, making it suitable for a specific application.

In an example, the system has a fuel pellet or a container comprising the fuel pellet inside disposed within the reactor region and is coupled to the plurality of cavity regions as each of the plurality of cavity regions spatially intersect within the reactor region to provide an energy level sufficient to ignite the fuel pellet for a fusion reaction. A tube or other fuel supply guiding component is configured from the fuel pellet or the container supply device to the reaction region. In an example, the container is a hohlraum, which will be described in more detail below. In the present invention, the OEC laser are used to compress the target uniformly and symmetrically. As mentioned above, hohlraum would not be required by using the OEC lasers.

In an example, the position of pellet or container is monitored by LIDAR and video camera and, feed back to the computer to synchronize with all of the laser light source, signals of photodiode located at backside of mirror, and the fuel pellet or the container delivery device.

In an example, the present system uses a plurality of high energy pulsed or CW lasers configured in the vacuum chamber to achieve a total of 1 Mega Joule (MJ) ˜20 MJ, 10 Tera Watt (TW) ˜10 Peta Watt (PW), or more energy. The cavity length can be 20 meters˜10 K meters, but can be smaller or larger in other examples. The frequency of pellet or container delivery into the reaction region can be about 1 Hz˜50 Hz and more or less in an example. The laser light source can each have a power of 0.01 Joule˜100 J, and a frequency of 100 KHz˜100 Mega Hertz.

In an example, a Fabry-Perot cavity is an optical resonator comprising two parallel mirrors with a high degree of reflectivity facing each other. The mirrors reflect light back and forth between them, creating an interference pattern that produces constructive and destructive interference. When light enters the cavity, it can either transmit through the cavity or reflect off one of the mirrors. The light that reflects off the mirrors interferes constructively with itself, reinforcing the light in the cavity. The light that transmits through the cavity interferes destructively with the reflected light, canceling it out. The distance between the mirrors determines the resonance of the cavity, which is the wavelength of light that resonates within the cavity. This resonance can be fine-tuned by changing the distance between the mirrors, allowing for precise control over the frequencies of light that are reflected and transmitted. Of course, one of ordinary skill in the art would recognize other variations, modifications, and alternatives.

While the above is a full description of the specific examples, various modifications, alternative constructions and equivalents may be used. As an example, the system and method can include any combination of elements described above, as well as outside of the present specification. In an example, the high intensity laser forms a resonator between the pair of mirror devices using constructive interference of each of the laser beams. In an example, the first path with the high intensity pulse laser is provided in a resonator device. In an example, the present invention provides a system and method to generate aa concentric or spherical resonator within a reaction region to focus laser light at a center of the reactor. Additionally, the terms first, second, third. and final do not imply order in one or more of the present examples. In a preferred example, the laser light is characterized by a green light, which reduces optical damage. Therefore, the above description and illustrations should not be taken as limiting the scope of the present invention which is defined by the appended claims.

1. A method of using an inertial nuclear fusion reactor using a laser device for energy generation, the method comprising:
maintaining a vacuum in a reactor housing, the reactor housing having an interior region and characterized by a diameter, the reactor housing having a reaction region within a vicinity of a spatially center region of the reactor housing and a peripheral region formed within an interior of the reactor housing, the peripheral region surrounding the reactor region;
emitting an electromagnetic radiation from a nanosecond (ns) laser light source comprising a first ns laser light source and a second ns laser light source, the first ns laser light source and the second ns laser light source configured, respectively, to emit the electromagnetic radiation coupled to a pair of mirror devices, the pair of mirrors configured, respectively, on the first end and the second end of a cavity region; the cavity length defined by spatial length between each pair of mirrors is larger than a diameter of the reactor housing;
propagating a first laser beam from the first ns laser light source and propagating a second laser beam from the second ns laser light source to collectively combine to increase in energy intensity from a first intensity to a second intensity to an Mth intensity for M cycles, where M is greater than 1,000 cycles at a cavity region, the cavity region being configured with a plurality of cavity regions numbered from 1 through N within the interior region of the reactor housing and spatially configured around the peripheral region such that each of the plurality of cavity regions extending from a first side of the peripheral region to a second side of the peripheral region, the first side opposing the second side, and forming a linear path along a diameter of the interior region, such that the plurality of cavity regions forms a hub and spoke configuration, each cavity region having a center region concentric with the reactor region and each cavity region has a first end coupled to the first side and a second end coupled to the second side of the peripheral region, where N is greater than 1;
using a plurality picosecond laser light sources numbered from 1 through P spatially configured with the reactor housing to emit a electromagnetic radiation from each picosecond (ps) laser light source coupled to an optical element, the optical element including at least a mirror or a lens, and pass through a transparent glass to enter the interior region of the reactor housing, and configured to form a focused laser beam from the plurality of picosecond laser light sources to irradiate into a fuel pellet with a predetermined spot size; and
initiating ignition of at least a deuterium and a tritium, a boron, a boron isotope 11, or a proton plus a boron isotope 11 provided in the fuel pellet or a container comprising the fuel pellet injected within the reactor region and operably coupled to the plurality of ps laser light sources at the reaction region of the reactor housing for the ignition at an intersection of the plurality of cavity regions using an energy level sufficient to compress the fuel pellet for a fusion reaction using the first laser beam and the second laser beam from each of the cavity regions.

2. The method of claim 1 wherein each of the ns laser light sources comprises a laser device configured to emit electromagnetic radiation at a wavelength ranging from 350 nm to 1070 nm and a frequency between 0.3 MHz and 3 MHz.

3. The method of claim 1 wherein each of the ps laser light sources comprises a laser device configured to emit electromagnetic radiation at a wavelength ranging from 350 nm to 1070 nm and a frequency between 1Hz and 20 Hz.

4. The method of claim 1 wherein the Mth intensified pulse from the ns laser light source is characterized by a frequency of 10 Hz.

5. The method of claim 1 wherein each of the ps laser light source with a frequency of 10 Hz.

6. The method of claim 1 further comprising using fuel pellet dispenser coupled to the reactor housing, the fuel pellet dispenser configured to inject the fuel pellet at a rate of 10 Hz.

7. The method of claim 4 wherein the Mth intensified pulse, each ps laser light source, and a pellet dispenser are synchronized with a frequency of 10 Hz.

8. The method of claim 1 wherein each of the pairs of mirror devices is spatially adjustable in a longitudinal direction along a direction of a length of the cavity from 10 centimeters to 100 centimeters.

9. The method of claim 1 wherein each of the plurality of cavity regions has a length of 100 meters to 200 meters.

10. The method of claim 1 wherein each of the plurality of cavity regions has a length of 150 meters.

11. The method of claim 1 wherein the reactor housing is characterized by the diameter ranging from 1 m to 50 m.

12. The method of claim 1 wherein each of the ps laser light sources comprises 10 small ps laser light sources, each of the small ps light sources has a pulse energy of about 1 kJ 2 with a frequency of 10 Hz.

13. The method of claim 1 wherein each of the ps laser light sources has a pulse energy of about 10 kJ with a frequency of 10 Hz.

14. The method of claim 1 wherein the plurality of ps laser light sources are focused to the predetermined spot size on the fuel pellet to achieve a pulse power density is more than 1×10²⁰ Wcm⁻², or more than 1×10²¹ Wcm⁻², or more than 1×10²² Wcm⁻².

15. The method of claim 1 wherein each of the ns laser sources has a pulse energy of about 0.1 J with a frequency of 1 MHz.

16. The method of claim 1 wherein the Mth intensified pulse has a pulse energy of about 10 kJ with a frequency of 10 Hz.

17. The method of claim 16 wherein N is more than 100.

18. The method of claim 1 wherein the Mth intensified pulse from the pair of ns laser light sources is focused into the fuel pellet such that the predetermined spot size is substantially a same size as the fuel pellet.

19. The method of claim 18 wherein the predetermined spot size ranges from 1 mmϕ to 5 mmϕ.

20. The method of claim 18 wherein the energy level is characterized by a pulse power density of more than 1×10¹³ Wcm⁻² on the fuel pellet.

21. The method of claim 18 wherein the energy level is characterized by a pulse power density of more than 1×10¹⁴ Wcm⁻² on the fuel pellet.

22. The method of claim 18 wherein the energy power level is characterized by pulse power density of more than 1×10¹⁵ Wcm⁻² on the fuel pellet.

23. The method of claim 18 wherein the energy power level is characterized by a pulse power density of more than 1×10¹⁶ Wcm⁻² on the fuel pellet.

24. The method of claims 1 wherein the Mth intensified pulse from the ns laser light source is irradiated on the fuel pellet to compress the fuel pellet for a time period of 1 ns˜20 ns, and thereafter the compression of the fuel pellet, the ps laser light source characterized by a higher power density, than the ns laser light source, is irradiated into the fuel pellet with the predetermined spot size, that is smaller than a spot size of the Mth intensified pulse, on the fuel pellet for the ignition.

25. An inertial fusion reactor system comprising:
a reactor housing having an interior region, an exterior region, and a reaction region configured within a center region of the interior region;
a plurality of picosecond laser light sources numbered from 1 to N, where N ranges from 1 to 20 arranged in a pattern around the center region such that a laser beam characterized by a wavelength, a pulse frequency, a pulse width, and a pulse energy emitted from each of the picosecond laser sources is targeted to a fuel pellet injected within the reaction region;
a plurality of Fabry Perot cavity regions numbered from 1 to M, where M is 50 to 500, arranged symmetrically around the center region and forming a hub and spoke pattern such that the hub is concentric with the reaction region; and
a pair of nanosecond laser light sources configured, respectively, to a first mirror device and a second mirror device coupled to each Fabry Perot cavity regions such that a first laser beam and a second laser beam from the pair of nanosecond laser light sources collectively propagate between the first mirror device and the second mirror device to increase in energy intensity from a first intensity to a second intensity to an P^{th} intensity for P cycles of the combined laser beams, where P is greater than 10,000 cycles.

26. A method of initiating a fusion reaction, the method comprising:
irradiating a fuel pellet with first laser beam inside of a Fabry-Perot cavity having a first pulse power density emitted from a plurality of nanosecond laser light sources for a predetermined time; and
irradiating the fuel pellet with a second laser beam having a second pulse power density emitted from a plurality of picosecond laser light sources to cause ignition of a fusion reaction.

27. The method of claim 26 wherein the second pulse power density is greater than the first pulse energy power density.

28. The method of claim 26 wherein the irradiation of the second laser beam occurs within the predetermined time.

29. The method of claim 26 wherein each of the nanosecond laser light sources is characterized by a nanosecond pulse time ranging from 1 ns to 20 ns; and wherein each of the picosecond laser light sources is characterized by a picosecond pulse time ranging from 0.5 ps to 5 ps.

30. The method of claim 29 wherein the ps pulse is focused to the pellet after improving laser density distribution with deformable mirrors.

31. The method of claim 29 wherein the ns and ps pulses are focused to the pellet using concave mirrors.
